(19) United States
(12) Patent Application Publication
(10) Pub. No.: US 2004/0067084 A1
(43) Pub. Date: Apr. 8, 2004

(54) Cost per page indication

(76) Inventors: Wendy L. Zerza, Boise, ID (US); Vincent C. Skurdal, Boise, ID (US); Boyd Wilkes, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/266,459

(22) Filed: Oct. 8, 2002

(51) Int. Cl. B41J 11/44

(52) U.S. Cl. 400/76

(57) ABSTRACT

Apparatus, systems and methods provide a cost per page indication that reflects one or more consumable costs associated with a document. The document can be optionally modified responsive to the cost per page indication.

### FIELD

The present invention relates to printer technologies, and in particular to cost per page indication.

### BACKGROUND

There are many types of printing mechanisms. Different types of printing mechanisms are useful for different types of printing jobs. For example, inkjet printing is capable of producing high-quality color photographs from digital images. Some inkjet printing mechanisms use cartridges, often called “pens,” which eject drops of liquid colorant, referred to generally herein as “ink,” onto a page. Each pen has a printhead formed with very small nozzles through which the ink drops are fired. To print an image, the printhead is propelled back and forth across the page, ejecting drops of ink in a desired pattern as it moves. The particular ink ejection mechanism within the printhead can operate using a piezo-electric or a thermal principles. Other types of inkjet printers use individual pens rather than cartridges. Generally, four colors (black, cyan, magenta and yellow) need to be mixed to form an image.

Consumables are associated with each printing a job. Cartridges and the inks/toners therein are one type of consumable. The cost of these consumables can vary widely. And, depending on the requirements of a given print job and selected printer settings, inks/toners can be consumed in various quantities. Voluminous and rapid consumption of consumables can add up quickly in a given print job and become expensive. The cost of consumables for a given print job can be unexpected and frustrating.

Another consumable is the media, such as paper, on which a job is printed. Ordinary printing paper may be inexpensive. However, the cost of photo-grade media can be very high. Here too, the type of print media selected for a given print job can produce unexpected costs.

### BRIEF DESCRIPTION OF THE DRAWINGS

FIG. 1 is a perspective view of a printing apparatus according to one embodiment of the invention.

FIG. 2 illustrates a system according to an embodiment of the invention.

FIG. 3 is a diagram illustrating a system embodiment that includes a printer controller, a display, and a host computer.

FIG. 4 is a flow chart illustrating a method according to an embodiment of the invention.

FIG. 5 is a flow chart illustrating a method according to an embodiment of the invention.

FIG. 6 is a flow chart illustrating a method according to an embodiment of the invention.

FIG. 7 is a print display according to an embodiment of the invention.

FIG. 8 is a diagram illustrating a computer readable medium and associated instruction set according to an embodiment of the invention.

### DETAILED DESCRIPTION

The following description and the drawings are provided to illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of various embodiments of the invention is defined only by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

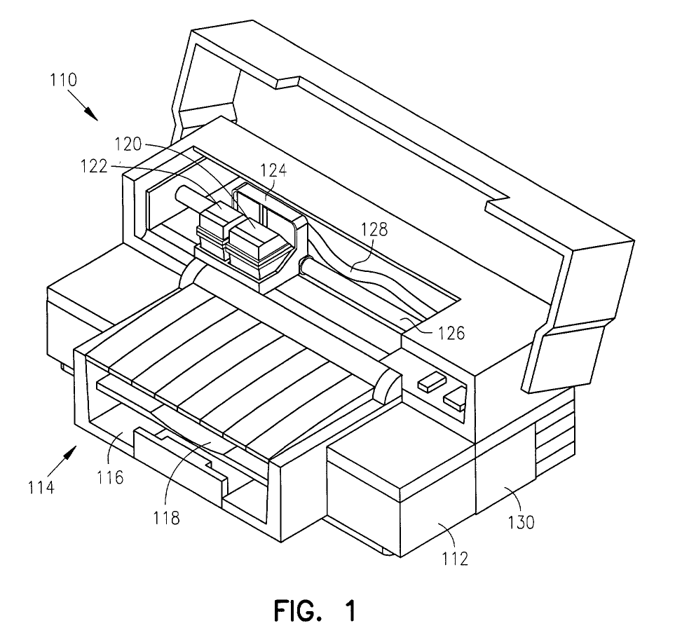

FIG. 1 illustrates a printing device 110 according to an embodiment of the invention. The embodiment of FIG. 1 illustrates an inkjet printer 110, which may be used in an office or home environment for producing business reports, printing correspondence, desktop publishing, reproducing pictures and the like. However, the invention is not so limited and can include a laser jet printer or other printers implementing the aspects of the present invention. In the embodiment of FIG. 1, the printer 110 includes a chassis 112 and a print media handling system 114 for supplying one or more print media, such as a sheet of paper, business card, envelope, or high-quality photo paper to the printer 110. As one of ordinary skill in the art will understand upon reading this disclosure, the print media can include any type of material suitable for receiving an image, such as paper card-stock, transparencies, mylar, and foils among others.

In the embodiment of FIG. 1, the print medium handling system 114 includes a feed tray 116, an output tray 118, and a series of rollers (not shown) for delivering sheets of print media from the feed tray 116 into position for receiving ink from a plurality of inkjet cartridges 120, 122. In the embodiment of FIG. 1, inkjet cartridge 120 is a multi-color ink cartridge and inkjet cartridge 122 is a black monochrome ink cartridge. As noted above, ink cartridges, with their respective inks/toners, and print media are consumables.

As shown in the embodiment of FIG. 1, the ink cartridges 120, 122 are transported by a carriage 124. The carriage 124 can be driven along a guide rod 126 by a drive belt/pulley and motor arrangement (not shown). As one of ordinary skill in the art will appreciate, in other printers the ink cartridges are transported by other mechanisms. Embodiments of the invention are not so limited.

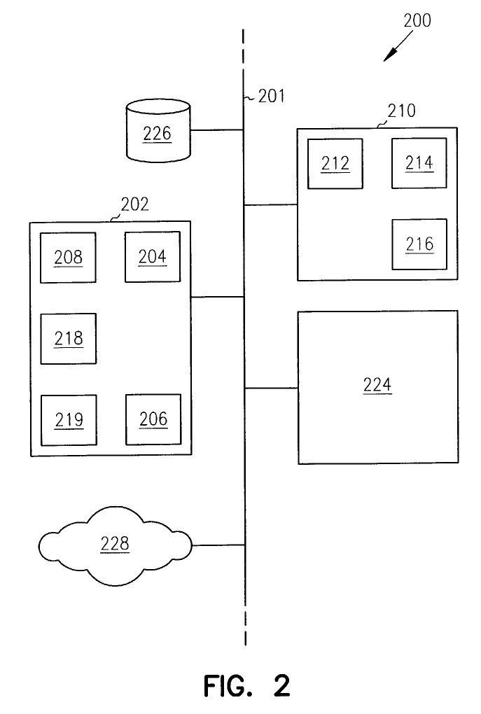

In the embodiment of FIG. 1, the cartridges 120, 122 selectively deposit one or more ink droplets on a sheet of paper or other print media in accordance with instructions received via a conductor strip 128 from a printer controller 130 which can be located within chassis 112. The controller 130 receives a set of print instructions from a print driver (e.g. element 208 illustrated in FIG. 2). The print driver can reside in a computing device coupled to the printer 110 via a network or the print driver can reside in the printer itself as in the case of a stand alone printing device, e.g. a photo printer kiosk or standalone appliance. As discussed in more detail below, a display can be associated with the printer 110 to display visual information to an operator. As such, a display is one form of user interface to the printer 110.

FIG. 2 illustrates a system 200 according to an embodiment of the invention. As shown in FIG. 2, the system 200 includes a remote terminal 202. In various embodiments, the remote terminal 202 can include a desktop computer, a laptop computer, a workstation, or other host computer. The remote terminal 202 can include a display 219, as well as one or more processors 204 and one or more memory devices 206 suitable for running software and/or application modules thereon. As one of ordinary skill in the art will understand upon reading this description, the software and/or application modules include any software and/or application modules suitable for carrying out the various aspects of the present invention.

In the embodiment shown in FIG. 2, the remote terminal 202 includes a printer driver 208. As one of ordinary skill in the art will understand upon reading this description, a printer driver 208 is operable to create an instruction set for a print job which can be sent to a printing engine for rendering an image. Printer driver 208 includes any printer driver suitable for carrying out various aspects of the present invention. That is, the printer driver 208 can take applications running on remote terminal 202 and transform them into a print job.

As shown in FIG. 2, remote terminal 202 is connected to a printer 210 within system 200. Printer 210 includes a printing engine 212, or printer raster image processor 212. Printer 210 can also include one or more processors 214 and one or more memory devices 216 suitable for running software and/or application modules thereon. Again, the software and/or application modules include any software and/or application modules suitable for carrying out the various aspects of the present invention.

System 200 includes a network 201 having data links. Network 201 can include any number of network types including, but not limited to a Local Area Network (LAN), a Wide Area Network (WAN), among others. Likewise, data links can include any combination of direct wired and wireless connections, including but not limited to electrical, optical and radio frequency (RF) connections.

In some embodiments, remote terminal 202 is connected to printer 210 via an external RIP (Raster Image Proscessor) (not shown). That is, a RIP (Raster Image Processor) which is external to the printer 210. As one of ordinary skill in the art will appreciate an RIP can include one or more processors and one or more memory devices suitable for running software and/or application modules thereon. In the embodiment of FIG. 2, a host based RIP 218 is illustrated residing on remote terminal 202.

As stated above, the software and/or application modules include any software and/or application modules suitable for carrying out the various aspects of the present invention. Such software and/or application modules can be resident in one location or in several and even many locations, such as in a distributed computing environment, throughout the system 200.

Further, as shown in the embodiment of FIG. 2, system 200 can include other peripheral devices 224, storage devices 226, and Internet connections 228. These devices 224, 226 and connections 228 can also be included within the network 201.

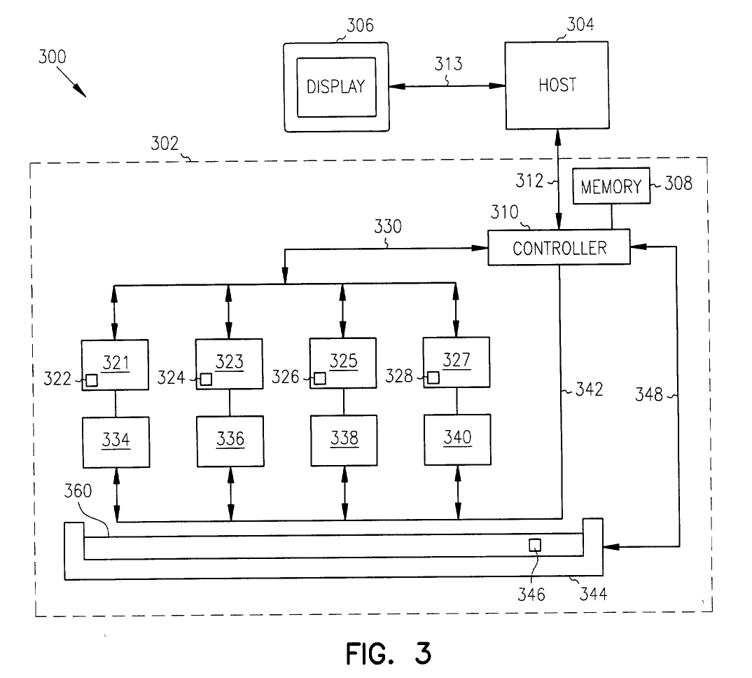

FIG. 3 is a diagram illustrating a system 300 embodiment that includes a printing device 302, a host computer 304, and a display 306. The printing device 302 includes a memory 308 and a print controller 310. The printing device or printer 302 includes one or more ink reservoirs 321, 323, 325 and 327 and one or more printheads 334, 336, 338 and 340 associated therewith. The controller 310 controls many aspects of the printer 302. That is, the controller 310 controls the transfer of information to ink reservoirs 321, 323, 325 and 327 via conductive path 330, as well as the control of information to and from the printheads 334, 336, 338 and 340. Information can be obtained from the memory 308 and/or elsewhere in system 300.

In some embodiments, the memory 308 includes an indication of the type of ink and the ink colors in the various reservoirs 321, 323, 325 and 327. The memory 308 can also contain information as to the levels of ink within the various reservoirs 321, 323, 325 and 327. In the embodiment of FIG. 3, a number of fluid level sensors 322, 324, 326, and 328 are shown with each fluid sensor associated with one of the ink reservoirs 321, 323, 325 and 327. The invention however is not limited to this particular sensor configuration and other sensor arrangements, suitable for carrying out various aspects described herein, are included within the scope of the invention. In the embodiment of FIG. 3, the fluid level sensors 322, 324, 326, and 328 are located to monitor an ink level in each of the various reservoirs. The fluid level determined by the fluid level sensors 322, 324, 326 can be placed into memory 308. Electrical contacts associated with each of the reservoirs 321, 323, 325 and 327 can receive and transmit signals between the reservoirs 321, 323, 325 and 327 and the controller 310 over conductive paths 330.

In the various embodiments, the controller 310 can selectively activate each printhead 334, 336, 338 and 340 to eject or deposit ink from the respective reservoirs 321, 323, 325 and 327 onto print media 360. The printheads 334, 336, 338 and 340 can be controlled by signals from the controller 310 over conductive paths 352. The printheads 334, 336, 338 and 340 are also capable of providing signals to the controller 310.

In the embodiment of FIG. 3, a conductive path 348 is provided to a media handling device 344, such as a paper tray, for controlling print media 360 transport. As one of ordinary skill in the art will appreciate upon reading this disclosure, other conductive paths will exist to control additional operations such as the movement of the carriage 124 shown in FIG. 1. Such details are not provided herein so as not to obscure the invention.

In one embodiment, attached to or associated with the media handling device 344 is a media type sensor 346. The media type sensor 346 can sense the type of media 360 associated with a particular print job. In various embodiments, the media type sensor 346 includes a sensor for reading indicia. The indicia that can be read with various media type sensors 346 include bar codes, labels, switch bumps, magnetically readable media, radio frequency signals, read-only chips, and other indicia.

As shown in FIG. 3, the controller 310 is also communicatively coupled to a host computer 304. The host computer 304 can include a remote terminal 202 as shown in FIG. 2. The host computer 304 is communicatively coupled to the display device 306 via conductive path 313. As discussed in more detail below, the display device 306 can provide a cost per page indication that reflects one or more consumable costs, such as inks/toners and print media, associated with a document. The host computer 304 provides image information, such as a print instruction set, to the controller 310 by way of a data link or conductive path 312. In this application, conductive paths or data links are intended to include any one or combination of signal media such as hardwired electrical links, wireless radio frequency links, infrared links, optical links and the like. Thus, data link 312 transfers information between the host computer 304 and the printing device 302.

Various parameters can be stored in the storage device or memory 308, including the actual count of ink drops emitted from a particular printhead 334, 336, 338 and 340, data associated with an ink reservoir or container 321, 323, 325 and 327, as well as the ink type and color, the container size, the age of the ink, the printer model or identification number, and cartridge usage information.

Information relating to the print media 360 can also be stored within the memory. In some embodiments, information on the print media 360 is obtained from the media type sensor 346. The media type sensor 346 senses the type and cost of the print media associated with a particular print job. The media type sensor can be any type of sensor, including a sensor for reading indicia on the print media itself. The indicia that can be read with different types of sensors include bar codes, labels, switch bumps, magnetically readable media, radio or other frequency signals, optical/gloss reflectivity, and read-only chips among others.

A print command or print instruction set sent from the host computer 304 to the controller 310 will contain information on a selected print media type for a particular print job. In some embodiments, where multiple print media trays are associated with a printer, the print command will contain information designating a particular tray from which to select print media for a given print job.

In some embodiments, information in the print command relating to a resolution setting will be used indicate the type of print media to be used for a particular print job. For example, a resolution setting of 2400 dots per inch (dpi) can be used to indicate that a high-quality photo type print media is to be used for a particular print job. In some embodiments, information in the print command includes a printer setting such as standard or economy mode.

In various embodiments, the cost per page associated with a document takes into account the quantity and type of print media for a print job. In some embodiments, the cost per page associated with a document takes into account the printer settings, which can include an economy mode, quantity draft mode, a standard mode, a simplex or duplex setting, a resolution setting, a printer speed setting, a printer selection setting, and an image enhancement algorithm selection among others. Examples of image enhancement algorithms include scaling, halftoning, and dithering algorithms among others.

The controller 310 is an information handling system and can include a microprocessor, dedicated controller, or a similar device. The controller 310 is capable of detecting the colors of inks or other materials contained in each of the reservoirs 321, 323, 325 and 327. In some embodiments, the controller 310 detects a color from indicia associated with the reservoirs 321, 323, 325 and 327. The indicia can be any type of readable indicator including bar codes, switch bumps, magnetically readable media, radio frequency signals, read-only chips and the like. In some embodiments, the controller detects the ink color contained in each of the reservoirs 321, 323, 325 and 327 from a location of a cartridge containing the ink reservoir in the print device 302. In some embodiments, data associated with ink in each of the reservoirs 321, 323, 325 and 327 is obtained through electrical contacts associated with the cartridge or reservoir 321, 323, 325 and 327.

In various embodiments, the controller 310 is operable to detect a consumables cost using one or more sensors to read indicia associated with one or more consumables. A print command or print instruction set sent from the host computer 304 to the controller 310 will contain information setting the parameters for a particular print job, e.g. color information, resolution information, print media, and the like.

In various embodiments, providing a cost per page associated with a document includes using software operable to interpret a set of consumable types and a printer setting chosen for the document. In various embodiments, software is operable to evaluate a cost of consumables associated with a document as the document is being created by an application running on the host computer 304.

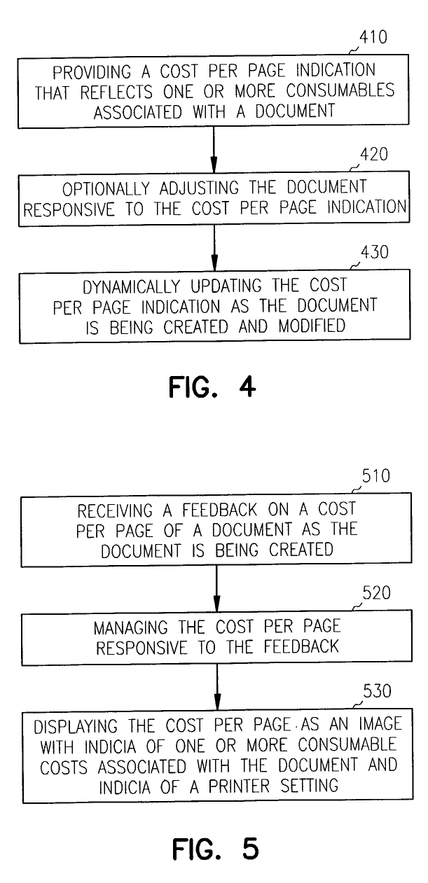

FIGS. 4-6 are flow charts illustrating various method aspects of the invention. As one of ordinary skill in the art will understand upon reading this disclosure, the methods can be performed by software, application modules, and computer executable instructions, operable on a system such as those shown in FIGS. 2 and 3, to achieve the same. Embodiments, of the invention, however, are not limited to any particular operating environment or software written in a particular programming language.

FIG. 4 is a flow chart illustrating a method according to an embodiment of the invention. In FIG. 4, the method includes providing a cost per page indication that reflects or accounts for one or more consumables associated with a document at block 410. In various embodiments, indicating a cost per page which accounts for one or more consumables includes accounting for consumables selected from a print media type and one or more inks/toners. In various embodiments, indicating a cost per page which accounts for one or more consumables includes accounting for a printer setting. In FIG. 4, the method includes optionally adjusting the document print job responsive to the cost per page indication at block 420. In various embodiments, optionally adjusting the document responsive to the cost per page indication includes changing at least one of a consumable selection and a printer setting. At 430, the method includes dynamically updating the cost per page indication as the document is being created. In this manner, a user will receive real-time feedback on a current cost of printing the document as it is created and modified.

In various embodiments, indicating a cost per page associated with a document includes indicating the cost per page in a print dialog box on a display. In various embodiments, indicating a cost per page associated with a document includes indicating the cost per page in an application being used to create the document. The document can be created and displayed on a host computer.

FIG. 5 is a flow chart illustrating a method according to an embodiment of the invention. In FIG. 5, the method includes receiving a feedback on a cost per page of a document as the document is being created at block 510. Receiving feedback on the cost per page of the document includes displaying the cost per page as an image within the document. Displaying the cost per page as an image includes displaying an image with indicia of one or more consumable costs associated with the document and indicia of a printer setting.

In block 520, the method includes managing the cost per page responsive to the feedback received. In various embodiments, managing the cost per page responsive to the feedback includes managing a consumable usage in view of one or more consumable costs. Managing the cost per page responsive to the feedback includes selecting one or more alternative consumables for use in the document. Selecting one or more alternative consumables includes selecting an alternative consumable such as a different ink/toner and a different print media type. Managing the cost per page responsive to the feedback can also include selecting one or more alternative printer settings. Selecting one or more alternative printer settings can include selecting a different color gamut and/or selecting a different resolution setting, among others.

In block 530, the method includes displaying the cost per page as an image with indicia of one or more consumable costs associated with the document and indicia of a printer setting.

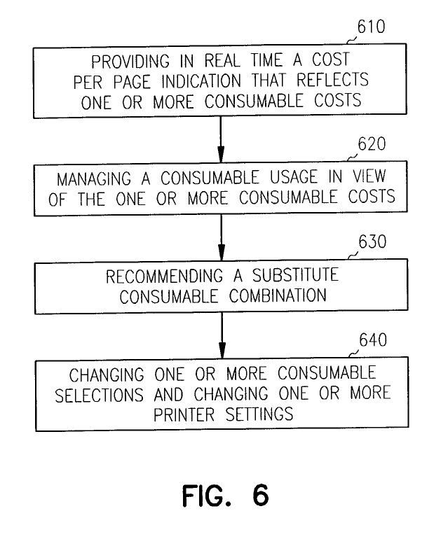

FIG. 6 is a flow chart illustrating a method according to an embodiment of the invention. In FIG. 6, the method includes providing in real-time a cost per page indication that reflects one or more consumable costs at block 610. In various embodiments providing a cost per page indication includes providing a total price for printing a selected page of the document and a total price for printing all of a document. Providing a cost per page indication that reflects one or more consumable costs includes detecting a set of consumable types and detecting a printer setting chosen for a document. In block 620, the method includes managing a consumable usage in view of the one or more consumable costs. In block 630, the method includes recommending a substitute consumable combination. In FIG. 6, managing in block 620 and/or recommending in block 630 can include changing one or more consumable selections and changing one or more printer settings as shown in block 640. Changing one or more consumables includes changing one or more of a color, a background, and a print media type for a document. Changing one or more printer settings includes changing a printer speed, changing a printer mode setting, changing a simplex or duplex setting, and changing a printer selection.

Thus, providing a cost per page indication that reflects one or more consumable costs and printer settings can facilitate user control over consumable usage and the cost of printing a document prior to actually printing the document. In this manner, unexpected consumable costs are avoided and consumable usage is managed.

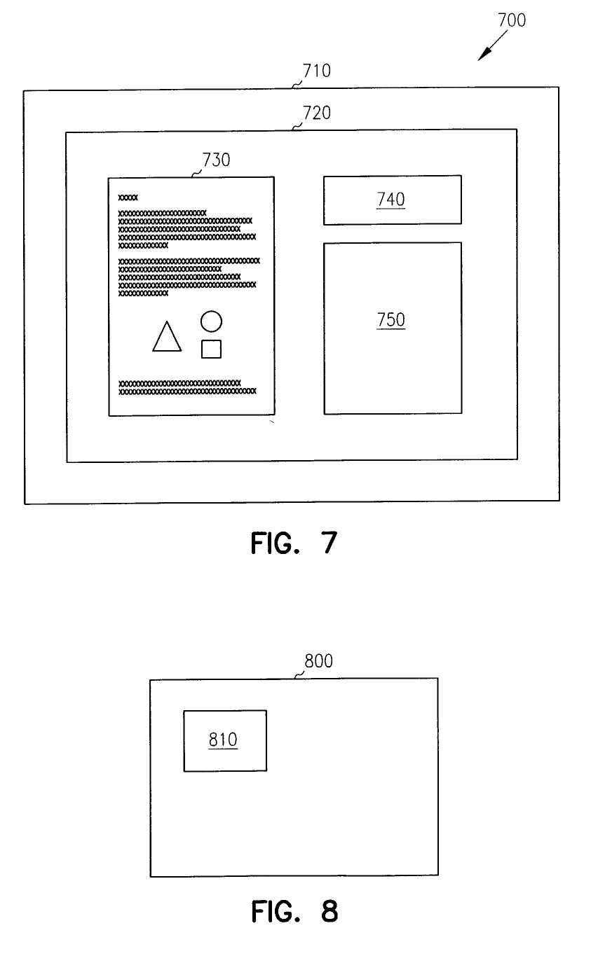

FIG. 7 illustrates an embodiment of a display 710 as can be included within systems 200 and 300 of FIGS. 2 and 3. As described above, methods for the various embodiments of the invention can be performed by software, application modules, and computer executable instructions, operable on such systems. In FIG. 7, a display 710 is provided. A screen 720 is shown within the display 710. The display 710 can include a cathode ray tube, a field emission device (FED), a flat panel display with an active matrix array of thin film transistors, or other suitable user interfaces of the like. Applications running on a system are viewable on the screen 720 of the display. One or more applications can be viewable at one time such as in a Microsoft Windows operating environment. Display 710 is used to view a document 730 on the screen 720 as it is being created and modified. In the embodiment of FIG. 7, an indication 740 of a cost per page to print the document is provided. In various embodiments, the indication 740 is an image, print dialog box, or other indicia which takes into account consumable costs and printer settings.

In some embodiments, the indication 740 is provided automatically and dynamically adjusts as the document 730 is created and modified. In some embodiments, the indication 740 appears within a print dialogue box when a print command is actuated. In some embodiments, the indication 740 is provided within document 730. In various embodiments, the display 710 includes a recommendation 750 for optionally adjusting one or more consumables and/or one or more printer settings for the document 730. That is, the recommendation 750 can include one or more alternative consumables and/or one or more alternative printer settings. Thus, in various embodiments, a user is afforded the opportunity to view, evaluate, and act upon the cost of printing the document 730.

FIG. 8 is a schematic diagram illustrating a computer-readable medium 800 and an associated instruction set 810, according to one or more embodiments of this invention. The computer-readable medium 800 can be any number of computer-readable media including a floppy drive, a hard disk drive, a network interface, a magnetic medium, an rf signal, a carrier wave, an interface to the internet, or the like. The computer-readable medium 800 can also be a hard-wired link for a network or an infrared or radio frequency carrier. The instruction set 810 can be any set of instructions that are executable by an information handling system associated with the methods discussed. For example, the instruction set can include an instruction set for performing the methods discussed with respect to FIGS. 4-6. Other instruction sets can also be placed on the computer-readable medium 800.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method for consumables management, comprising:
indicating a cost per page associated with a print job, wherein the cost per page accounts for a consumables cost and a printer setting; and
optionally adjusting the print job responsive to the cost per page indication.

2. The method of claim 1, wherein indicating a cost per page which accounts for a consumables cost includes accounting for consumables selected from a print media type and one or more inks/toners.

3. The method of claim 1, wherein indicating a cost per page which accounts for a printer setting includes accounting for a printer setting selected from an economy mode, a standard mode, a simplex or duplex setting, a resolution setting, a printer speed setting, a printer selection setting, and an image enhancement algorithm selection.

4. The method of claim 1, wherein indicating a cost per page associated with a print job includes providing a real-time feedback of a current cost per page for printing a document as the print job is being created.

5. The method of claim 1, wherein indicating a cost per page associated with a print job includes indicating the cost per page in a status bar.

6. The method of claim 1, wherein indicating a cost per page associated with a print job includes indicating the cost per page within an application being used to create a document.

7. The method of claim 1, wherein optionally adjusting the print job responsive to the cost per page indication includes changing at least one of a consumable selection and a printer setting.

8. A method for document cost management, comprising:
receiving a feedback on a cost per page of a document as the document is being created; and
managing the cost per page responsive to the feedback.

9. The method of claim 8, wherein receiving the feedback on the cost per page of the document includes displaying the cost per page as an image within the document.

10. The method of claim 9, wherein displaying the cost per page as an image includes displaying an image with indicia of one or more consumable costs associated with the document and indicia of a printer setting.

11. The method of claim 8, wherein managing the cost per page responsive to the feedback includes selecting one or more alternative consumables for use in the document.

12. The method of claim 11, wherein selecting one or more alternative consumables includes selecting an alternative consumable selected from an ink/toner and a print media type.

13. The method of claim 8, wherein managing the cost per page responsive to the feedback includes selecting one or more alternative printer settings.

14. The method of claim 13, wherein selecting one or more alternative printer settings includes selecting at least one of a different color gamut and a different density setting.

15. A set of instructions executable by an information handling system, comprising:
providing in real-time a cost per page indication that reflects one or more consumable costs; and
managing a consumable usage responsive to the one or more consumable costs.

16. The set of instructions of claim 15, wherein providing a cost per page indication that accounts for one or more consumable costs includes indicating a consumable cost associated with a printer setting.

17. The set of instructions of claim 15, wherein providing a cost per page indication that reflects one or more consumable costs includes one or more consumable costs associated with an ink/toner selection and a print media selection.

18. The set of instructions of claim 15, wherein the set of instructions for managing a consumable usage includes a set of instructions for recommending a substitute consumable combination.

19. The set of instructions of claim 15, wherein the set of instructions for managing a consumable usage includes a set of instructions for changing a printer setting.

20. The set of instructions of claim 15, wherein the system further includes a computer readable medium, the computer readable medium including the set of instructions.

21. A system, comprising:
a host computer including an application for creating a document;
a display associated with the host computer;
a printer having one or more sensors, the printer operable to print the document created on the host computer;
means for detecting a consumables cost associated with the document, wherein the consumables cost includes all network costs associated with a print job; and
means for controlling the consumables cost.

22. The system of claim 21, wherein the means for detecting a consumables cost includes software for using the one or more sensors to read indicia associated with one or more consumables.

23. The system of claim 21, wherein the means for detecting a consumables cost includes software operable to evaluate a cost of consumables associated with the document as the document is being created.

24. The system of claim 21, wherein the means for detecting a consumables cost includes software operable to interpret a set of consumable types and a printer setting chosen for the document.

25. The system of claim 21, wherein the means for controlling the consumables cost includes software operable to optionally provide one or more alternative consumable selections.

26. The system of claim 21, wherein the means for controlling the consumables cost includes software operable to provide an indicia of a cost per page while changing one or more consumables and printer settings associated with the document.

27. A computer readable medium having instructions for performing a method, comprising:
providing a cost per page indication that reflects one or more consumable costs associated with a document; and
optionally adjusting the document responsive to the cost per page indication.

28. The medium of claim 27, wherein providing a cost per page indication that reflects one or more consumable costs includes dynamically updating the cost per page indication as the document is being created and modified.

29. The medium of claim 27, wherein providing a cost per page indication that reflects one or more consumable costs includes detecting a set of consumable types and detecting a printer setting chosen for the document.

30. The medium of claim 27, wherein providing a cost per page indication that reflects one or more consumable costs includes providing indicia of one or more consumable costs and indicia of a printer setting within a document prior to printing the document.

31. The medium of claim 27, wherein optionally adjusting the document includes selecting from a different set of available consumables and a different set of printer settings.

32. The medium of claim 31, wherein selecting from a different set of available consumables includes changing one or more of a color, a background and a print media type.

33. The medium of claim 31, wherein selecting from a different set of printer settings includes changing at least one of a printer mode setting, a simplex or duplex setting, and a printer selection.

34. The medium of claim 27, wherein providing a cost per page indication that reflects one or more consumable costs associated with a document includes providing a total price for printing a selected page of the document and a total price for printing all of the document.

35. The medium of claim 27, wherein the medium includes a carrier wave.
